(19) United States
(12) Patent Application Publication
(10) Pub. No.: US 2022/0151453 A1
(43) Pub. Date: May 19, 2022

(54) Electromagnetic Pickup Wand

(71) Applicant: Bassam Ramadan, Maywood, NJ (US)

(72) Inventor: Bassam Ramadan, Maywood, NJ (US)

(21) Appl. No.: 16/952,889

(22) Filed: Nov. 19, 2020

(51) Int. Cl. A47L 13/41; B25J 1/04

(52) U.S. Cl. CPC A47L 13/41; B25J 1/04

(57) ABSTRACT

An electromagnetic pickup wand allows a user to pick up magnetic toy articles without having to bend down. The electromagnetic pickup wand contains a handle, a pole, a base, an electromagnet, and a switch. The electromagnet contains a coil, a rod, and a power source. The handle and the base are terminally positioned opposite to each other along the pole. The electromagnet is positioned within the pole. The electromagnet is electronically connected to the base, where the electromagnet is configured to magnetically engage with a magnetic element when the electromagnet is activated. The magnetic element is constructed out of a blend of magnetite sand and ABS material. The coil traverses along the rod. The power source is positioned within the handle. The switch, power source, the coil, and the base are electrically connected to each other.

### FIELD OF THE INVENTION

The present invention relates to collector devices, specifically electromagnetic collector devices used to pick-up magnetic objects.

### BACKGROUND OF THE INVENTION

Toy building blocks and other small toys are typically left behind after play. As will be appreciated, manually retrieving these toys scattered about upon the ground is extremely time-consuming. The use of brooms and similar devices has proven unsuccessful, since such devices simultaneously gather all manner of other undesirable products, such as dust, lint, and dirt which must be subsequently removed. Such devices are also unsuitable to use in carpeted surfaces. Hence, it is desirable to provide a collector device which can be used to quickly retrieve a number of toys from an area without gathering trash and other undesired objects.

Moreover, manual collection of these toys is physically quite demanding. The individual's hands quickly weary from repeated reaching, grasping, and contacting the toys, especially in hard to reach areas. Continual bending over a long period of time may unduly strain the individual's back and leg muscles and overtax the respiratory and circulatory systems. Hence it is desirable to provide a device which permits an individual to retrieve a plurality of toys from a large area without handling each toy and while maintaining a generally erect posture.

### SUMMARY OF THE INVENTION

The present invention is an electromagnetic pickup wand. The electromagnetic pickup wand comprises a handle, a pole, a base, an electromagnet, and a switch. The electromagnet comprises a coil, a rod, and a power source. The handle and the base are terminally positioned opposite to each other along the pole. The electromagnet is positioned within the pole. The electromagnet is electronically connected to the base, where the electromagnet is configured to magnetically engage with a magnetic element when the electromagnet is activated. In the preferred embodiment of the present invention, the magnetic element is constructed out of magnetite sand. More specifically, the magnetic element may take the form of toy building block constructs made out of ABS material with magnetite sand imbued along the ABS material. In various embodiments, the magnetic element may take the form of any other suitable article designed to be picked up by the electromagnetic pickup wand. The coil traverses along the rod. The power source is positioned within the handle. The switch, power source, the coil, and the base are electrically connected to each other.

### BRIEF DESCRIPTION OF THE DRAWINGS

FIG. 1 is a top perspective view of the present invention in an extended configuration.

FIG. 2 is a top perspective view of the present invention in a retracted configuration where a base is tilted slightly along a pole.

FIG. 3 is a bottom perspective view of the present invention.

FIG. 4 is a bottom perspective view of the present invention that shows a plurality of magnetic elements being magnetically attached to the base.

FIG. 5 is a side view of the present invention.

FIG. 6 is a cross sectional view of the present invention taken along cutting lines A-A in FIG. 5.

FIG. 7 is a circuit diagram used in the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

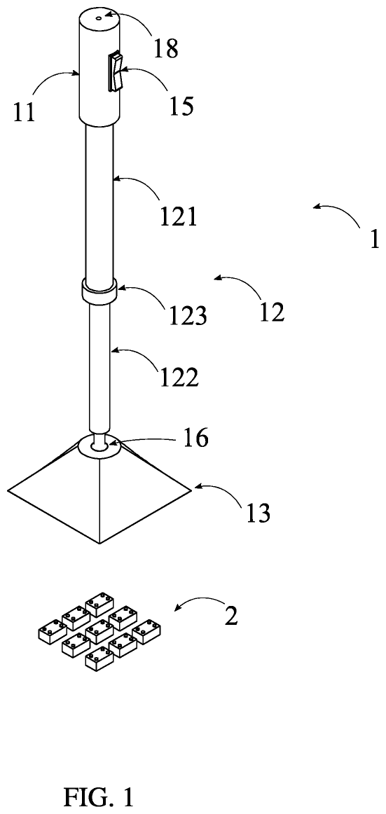

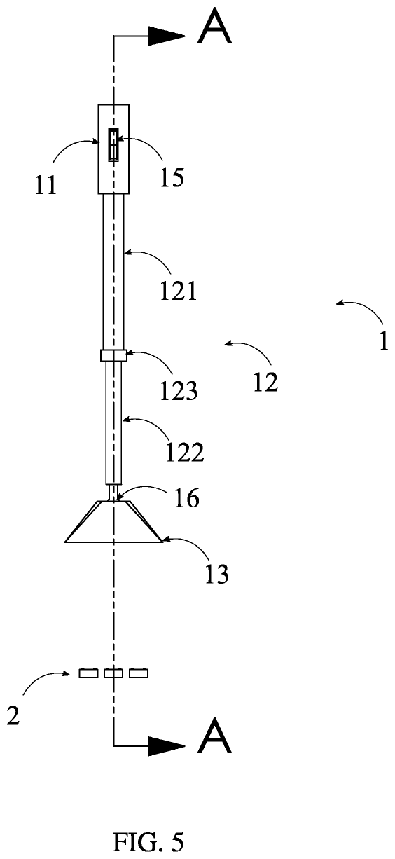

The present invention is an electromagnetic pickup wand 1, as shown in FIGS. 1-6. The electromagnetic pickup wand 1 comprises a handle 11, a pole 12, a base 13, an electromagnet 14, and a switch 15. In the preferred embodiment of the present invention, the electromagnetic pickup wand 1 is made out of any suitable material and construction.

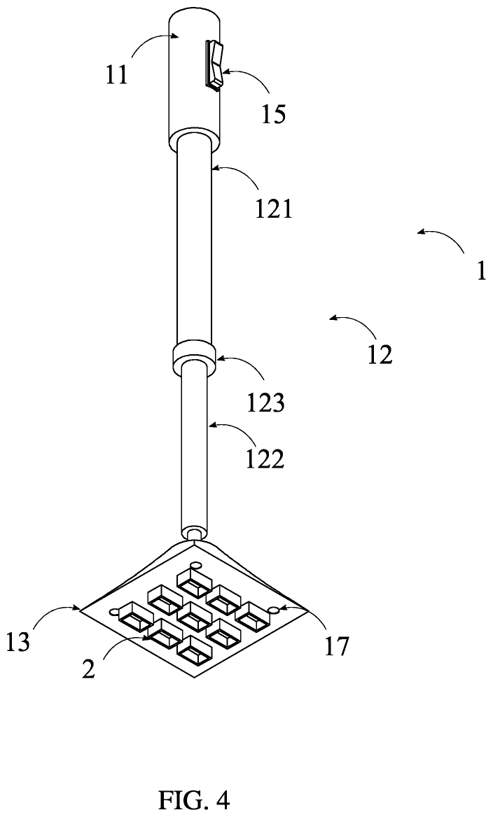

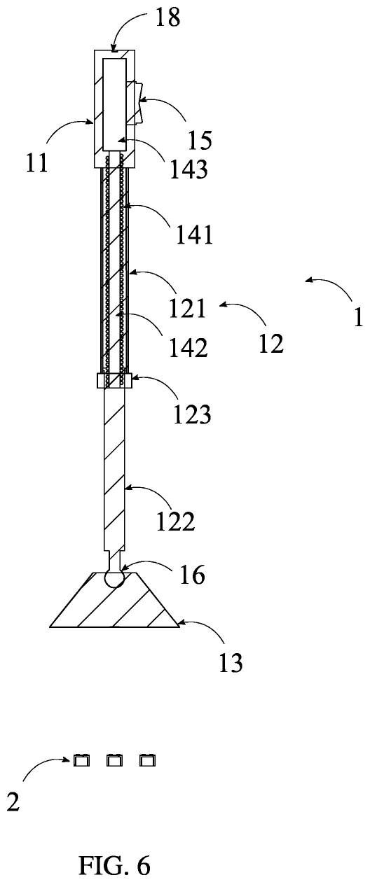

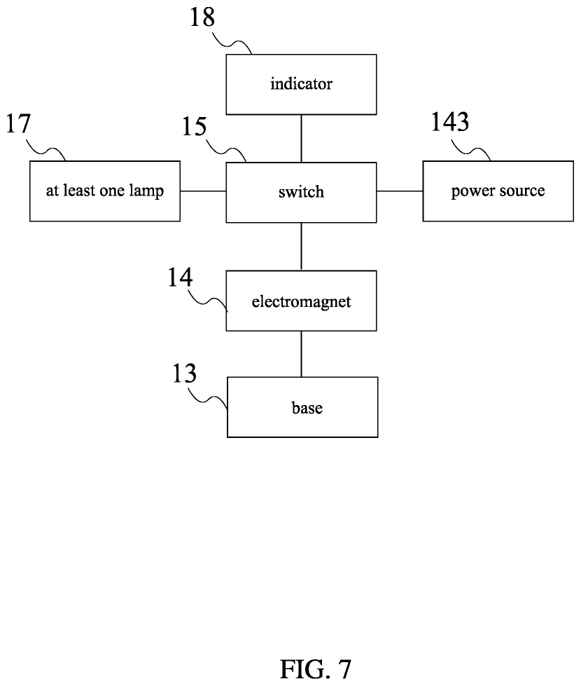

In the preferred embodiment of the present invention, the electromagnetic pickup wand 1 is scaled to any suitable size and stature. The electromagnet 14 comprises a coil 141, a rod 142, and a power source 143, as shown in FIG. 7. In reference to FIGS. 1-6, the handle 11 and the base 13 are terminally positioned opposite to each other along the pole 12. The electromagnet 14 is positioned within the pole 12, as shown in FIG. 6. The electromagnet 14 is electronically connected to the base 13, where the electromagnet 14 is configured to magnetically engage with a magnetic element 2 when the electromagnet 14 is activated, as shown in FIG. 4. In the preferred embodiment of the present invention, the magnetic element 2 is constructed out of magnetite sand. More specifically, the magnetic element 2 may take the form of toy building block constructs made out of ABS material with magnetite sand imbued along the ABS material. In various embodiments, the magnetic element 2 may take the form of any other suitable article designed to be picked up by the electromagnetic pickup wand 1. In reference to FIG. 6, the coil 141 traverses along the rod 142. The power source 143 is positioned within the handle 11. The switch 15, power source 143, the coil 141, and the base 13 are electrically connected to each other, as shown in FIG. 7. In the preferred embodiment of the present invention, the base 13, the rod 142, and the coil 141 are constructed out of a conductive material or any other suitable material such as, but not limited to steel, copper, aluminum, or any other suitable material. In the preferred embodiment of the present invention, the switch 15 may take the form of a toggle switch, such that the user can activate or deactivate the electromagnetic pickup wand 1 at will.

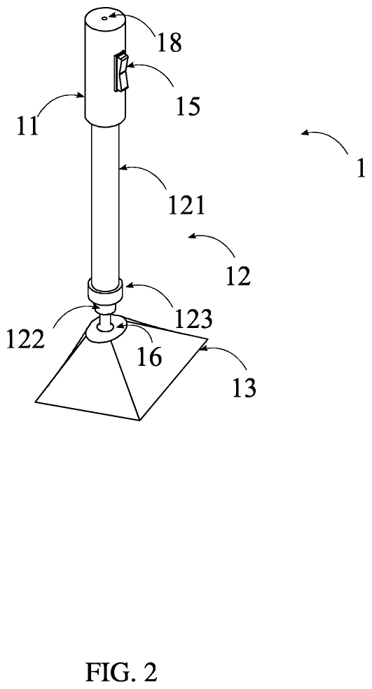

The pole 12 comprises a first section 121, a second section 122, and a locking mechanism 123, as shown in FIGS. 1-6. The first section 121 is connected adjacent to the handle 11. The first section 121 and the second section 122 are telescopically connected to each other through the locking mechanism 123. In the preferred embodiment of the present invention, the pole 12 may take the form of an adjustable, telescopic pole that allows the user to extend or retract the electromagnetic pickup wand 1 in length, as shown in FIG. 2. In the preferred embodiment of the present invention, the locking mechanism 123 fixes the adjusted length of the pole 12 to a desired length. In one embodiment, the locking mechanism 123 may take the form of a locking knob type locking mechanism 123 but may take the form of any other suitable locking mechanism 123.

In the preferred embodiment of the present invention, the pole 12 is hingedly connected adjacent to the base 13 through an articulation element 16, as shown in FIGS. 1, 2, 5-6. The articulation element 16 may take the form of a movable joint between the pole 12 and the base 13, such that the base 13 is angularly adjustable along the pole 12, as shown in FIG. 2. This allows the user to configure the base 13 to any desired position. In the preferred embodiment of the present invention, the articulation element 16 may take the form of a ball and socket joint, but may take the form of any other suitable articulation element 16, such as, but not limited to rotational hinges, flex joints, or any other suitable type of movable joint.

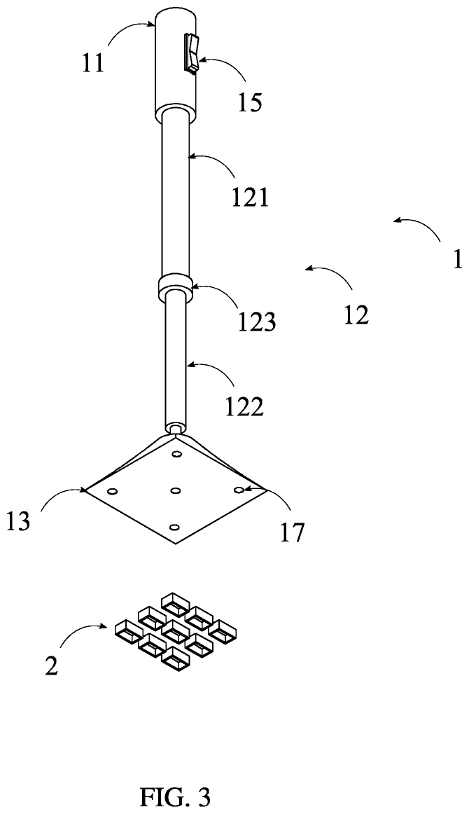

The electromagnetic pickup wand 1 further comprises at least one lamp 17, as shown in FIGS. 3-4 and 7. The at least one lamp 17 is distributed about the base 13. The at least one lamp 17 is electrically connected to the switch 15. In the preferred embodiment of the present invention, the at least one lamp 17 projects illumination from the base 13, allowing the user to use the electromagnetic pickup wand 1 in dim areas.

An electromagnetic pickup wand 1 further comprises an indicator 18, as shown in FIGS. 1-2 and 7. The indicator 18 is connected adjacent to the handle 11. The indicator 18 is electrically connected to the switch 15. In the preferred embodiment of the present invention, the indicator 18 may take the form of an LED indicator 18 that lets the user know if the device is on. The indicator 18 activates when the electromagnetic pickup wand 1 is activated.

Although the invention has been explained in relation to its preferred embodiment, it is to be understood that many other possible modifications and variations can be made without departing from the spirit and scope of the invention as hereinafter claimed.

What is claimed is:

1. An electromagnetic pickup wand comprising:
a handle;
a pole;
a base;
an electromagnet;
a switch;
the electromagnet comprising a coil, a rod, and a power source;
the handle and the base being terminally positioned opposite to each other along the pole;
the electromagnet being positioned within the pole;
the electromagnet being electronically connected to the base, wherein the electromagnet is configured to magnetically engage with a magnetic element when the electromagnet is activated;
the coil traversing along the rod;
the power source being positioned within the handle; and
the switch, power source, the coil, and the base being electrically connected to each other.

2. An electromagnetic pickup wand as claimed in claim 1 comprising:
the pole comprising a first section, a second section, and a locking mechanism;
the first section being connected adjacent to the handle; and
the first section and the second section being telescopically connected to each other through the locking mechanism.

3. An electromagnetic pickup wand as claimed in claim 1 comprising:
the pole being hingedly connected adjacent to the base through an articulation element.

4. An electromagnetic pickup wand as claimed in claim 1 comprising:
at least one lamp;
the at least one lamp being distributed about the base; and
the at least one lamp being electrically connected to the switch.

5. An electromagnetic pickup wand as claimed in claim 1 comprising:
an indicator;
the indicator being connected adjacent to the handle; and
the indicator being electrically connected to the switch.

6. An electromagnetic pickup wand as claimed in claim 1 comprising:
the base, the rod, and the coil being constructed out of a conductive material.

7. An electromagnetic pickup wand as claimed in claim 1, wherein the magnetic element is constructed out of magnetite sand.
